(19) United States
(12) Patent Application Publication
(10) Pub. No.: US 2023/0235847 A1
(43) Pub. Date: Jul. 27, 2023

(54) ELECTRONIC DEVICE SUPPORT FRAME

(71) Applicant: Shenzhen Lemore Marketing Consultancy Co.,Ltd, Shenzhen (CN)

(72) Inventors: Jiajia He, Shenzhen (CN); Haining Hou, Shenzhen (CN); Chenglan Huang, Shenzhen (CN)

(21) Appl. No.: 17/928,960

(22) PCT Filed: Sep. 30, 2021
(86) PCT No.: PCT/CN2021/122263

§ 371 Date: Dec. 1, 2022

(30) Foreign Application Priority Data
Jul. 31, 2020 (CN) 202021583734.4

(51) Int. Cl. F16M 11/10; F16M 11/38

(52) U.S. Cl. CPC F16M 11/10; F16M 11/38; H04M 1/04

(57) ABSTRACT

The present application discloses an electronic equipment support frame, which comprises a protective cover and a supporting structure, wherein the protective cover comprises a main plate and a side plate bent along the edge of the main plate, an accommodating space is enclosed by the main plate and the side plate for accommodating the electronic equipment, and a groove is formed on the side of the main plate facing away from the accommodating space; the supporting structure is disposed in the groove and comprises a first plate and a second plate, one end of the first plate is pivotally connected with the main plate, and the other end thereof is pivotally connected with the second plate. The electronic equipment support frame provided according to the present application can provide multi-angle support, and it has a higher adjustable range of supporting height and occupies a small area.

### TECHNICAL FIELD

The present application relates to the technical field of electronic equipment, and in particular, relates to an electronic equipment support frame.

### BACKGROUND

A tablet PC, also known as a Tablet Personal Computer (Tablet PC), is a small and portable personal computer with a touch screen serving as the basic input device. The touch screen (also known as digital panel technology) of the tablet PC allows a user to operate with a stylus or a digital pen instead of using the traditional keyboard or mouse. The user can input information through the built-in handwriting recognition, a soft keyboard on the screen, voice recognition or a real keyboard (if the model is equipped with a real keyboard).

Because the touch screen of the tablet PC is relatively large, it is easy to be damaged by external impact, and thus a protective cover for accommodating the tablet PC is required to prevent damage. At present, some protective covers of tablet PCs capable of providing support are available on the market, but these protective covers of tablet PCs usually only have one supporting angle, and have the disadvantage of insufficient supporting height.

### SUMMARY

The present application provides an electronic equipment support frame so as to solve the problems that the electronic equipment protective cover in the prior art can only provide one supporting angle and the supporting height is insufficient.

To solve the above problems, the present application provides an electronic equipment support frame, which comprises:

a protective cover, comprising a main plate and a side plate bent along the edge of the main plate, wherein an accommodating space is enclosed by the main plate and the side plate for accommodating the electronic equipment, and a groove is formed on the side of the main plate facing away from the accommodating space;

a supporting structure, being disposed in the groove and comprising a first plate and a second plate, wherein one end of the first plate is pivotally connected with the main plate, and the other end thereof is pivotally connected with the second plate;

wherein when the supporting structure is in a closed state, the supporting structure is folded and received in the groove to form an integrally-formed structure with the protective cover; when the supporting structure is in a supporting state, the first plate can rotate around the main plate and the second plate respectively to form multi-angle support.

Both ends of the first plate are provided with pivot shafts or pivot shaft sleeves for forming pivotal connection, and the inner wall of the second plate is provided with an accommodating groove for accommodating the pivot shafts or the pivot shaft sleeves, so as to reduce the thickness of the electronic equipment support frame in the closed state.

The electronic equipment support frame comprises two first mounting plates arranged on the main plate at intervals, one end of each of the two first mounting plates is provided with a first mounting shaft sleeve, one end of the first plate is provided with a first pivot shaft sleeve, the electronic equipment support frame further comprises two first rotating shafts corresponding to the first mounting shaft sleeves, the first rotating shafts pass through the first mounting shaft sleeve and the first pivot shaft sleeve, and the first plate body is pivotally connected by the cooperation of the first pivot shaft sleeve and the first rotating shaft.

The electronic equipment support frame comprises two second mounting plates arranged on the second plate at intervals, one end of each of the two second mounting plates is provided with a second mounting shaft sleeve, the other end of the first plate is provided with a second pivot shaft sleeve, the electronic equipment support frame further comprises two second rotating shafts corresponding to the second mounting shaft sleeves, the second rotating shafts pass through the second mounting shaft sleeve and the second pivot shaft sleeve, and the first plate body is pivotally connected by the cooperation of the second pivot shaft sleeve and the second rotating shaft.

The main plate comprises a main plate body and a mounting plate, wherein the main plate body is integrally formed with the side plate, the main plate body has a through groove, the mounting plate is arranged at the inner side of the main plate body, and the two first mounting plates are mounted on the mounting plate.

The mounting plate is further provided thereon with two first reinforcing plates for strengthening the strength of pivotal connection, and the two first reinforcing plates correspond to the two first mounting plates; the second plate is further provided thereon with two second reinforcing plates for strengthening the strength of pivotal connection, and the two second reinforcing plates correspond to the two second mounting plates.

The first rotating shaft comprises a first circular section and a first special-shaped section, the first circular section is matched and connected with the first mounting shaft sleeve, the first special-shaped section is connected with the first pivot shaft sleeve; the second rotating shaft comprises a second circular section and a second special-shaped section, wherein the second circular section is matched and connected with the second mounting shaft sleeve, and the second special-shaped section is connected with the second pivot shaft sleeve.

The cross sections of the first special-shaped section and the second special-shaped section are runway-shaped.

When the supporting structure is in a closed state, the second plate is in snap fit with the main plate.

The side plate is further provided with a pen cover groove for accommodating a pen cover, and the pen cover is used for accommodating a control pen used in cooperation with the electronic equipment.

According to the present application, the main plate of the electronic equipment support frame is provided with a groove, a supporting structure is arranged in the groove, and the supporting structure can be pivotally rotated twice; as compared to the electronic equipment support frame currently available, the electronic equipment support frame of the present application can provide multi-angle support and has a higher adjustable range of supporting height, so that the supporting height can be adjusted according to the actual use situation of consumers. Furthermore, the supporting structure can also be received, and the electronic equipment support frame only presents the appearance of a protective cover after being received, so that the area occupied is small.

### BRIEF DESCRIPTION OF THE DRAWINGS

In order to explain the technical solutions in the embodiments of the present application more clearly, attached drawings required in the description of the embodiments will be briefly introduced hereinafter; obviously, the attached drawings in the following description are only some embodiments of the present application, and other attached drawings can be obtained by those of ordinary skill in the art according to these attached drawings without any creative labor.

FIG. 1 is a schematic structural diagram of a first supporting angle in an embodiment of an electronic equipment support frame according to the present utility model, in which an electronic equipment is shown.

FIG. 2 is a schematic structural diagram of the electronic equipment support frame shown in FIG. 1 from another perspective.

FIG. 3 is a schematic structural diagram of a second supporting angle in an embodiment of the electronic equipment support frame according to the present utility model.

FIG. 4 is a schematic structural diagram of a third supporting angle in an embodiment of the electronic equipment support frame according to the present utility model.

FIG. 5 is a schematic structural diagram of an embodiment of the electronic equipment support frame of the present utility model when the supporting structure is in a closed state.

FIG. 6 is a schematic view illustrating the exploded structure of the electronic equipment support frame shown in FIG. 1.

FIG. 7 is a schematic structural diagram of the supporting structure of the electronic equipment support frame shown in FIG. 1.

FIG. 8 is a schematic view illustrating the exploded structure of the supporting structure shown in FIG. 7.

FIG. 9 is a schematic structural diagram of a first special-shaped section for a first rotating shaft of the supporting structure shown in FIG. 7.

### DETAILED DESCRIPTION

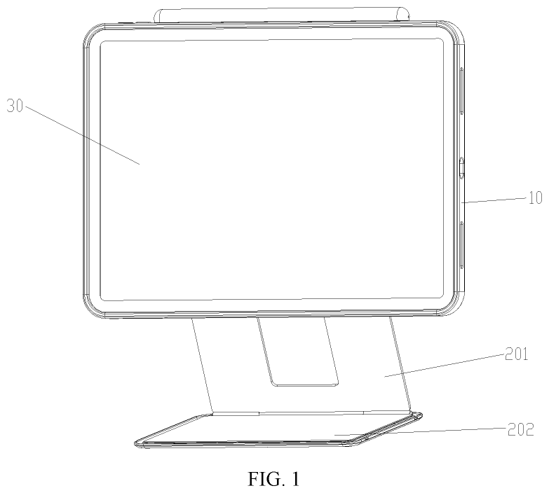

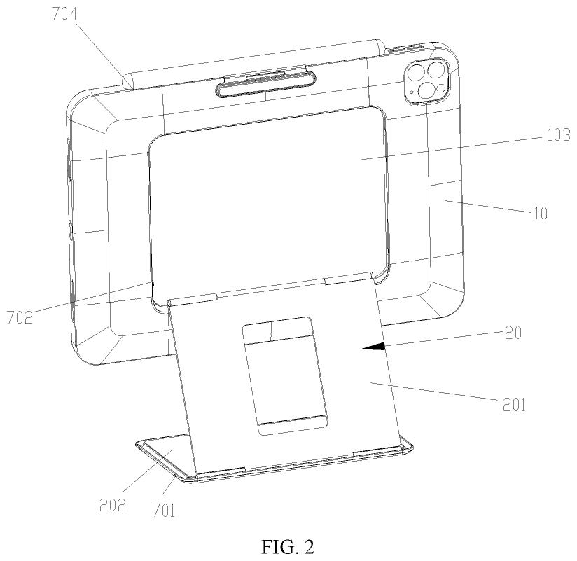

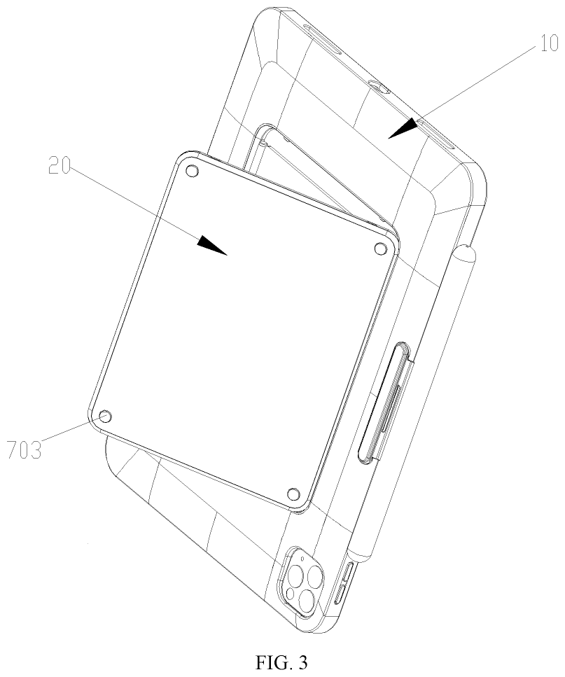

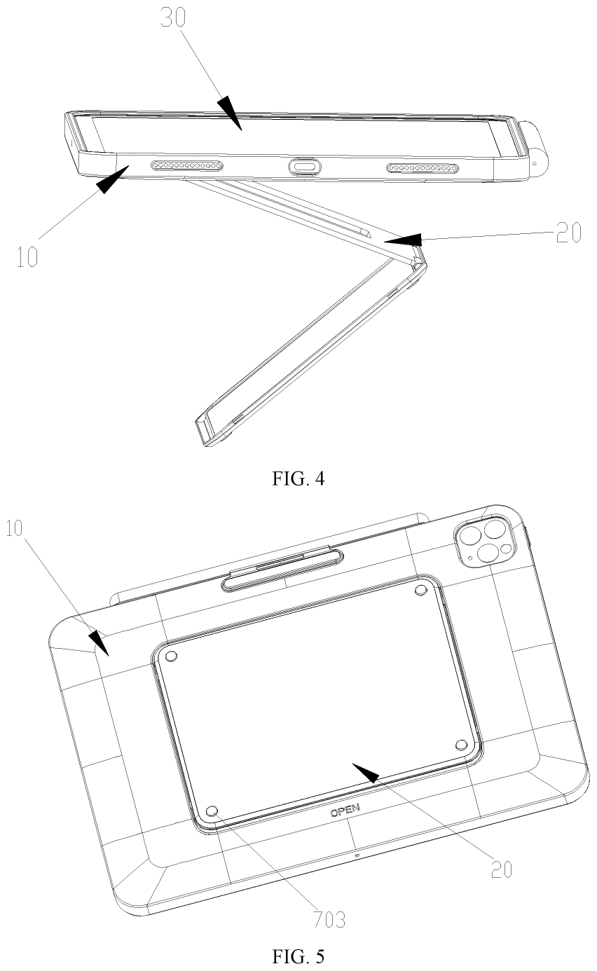

Please refer to FIG. 1 to FIG. 6, wherein FIG. 1 is a schematic structural diagram of a first supporting angle in an embodiment of an electronic equipment support frame according to the present utility model, in which an electronic equipment is shown; FIG. 2 is a schematic structural diagram of the electronic equipment support frame shown in FIG. 1 from another perspective; FIG. 3 is a schematic structural diagram of a second supporting angle in an embodiment of the electronic equipment support frame according to the present utility model; FIG. 4 is a schematic structural diagram of a third supporting angle in an embodiment of the electronic equipment support frame according to the present utility model; FIG. 5 is a schematic structural diagram of an embodiment of the electronic equipment support frame of the present utility model when the supporting structure is in a closed state; and

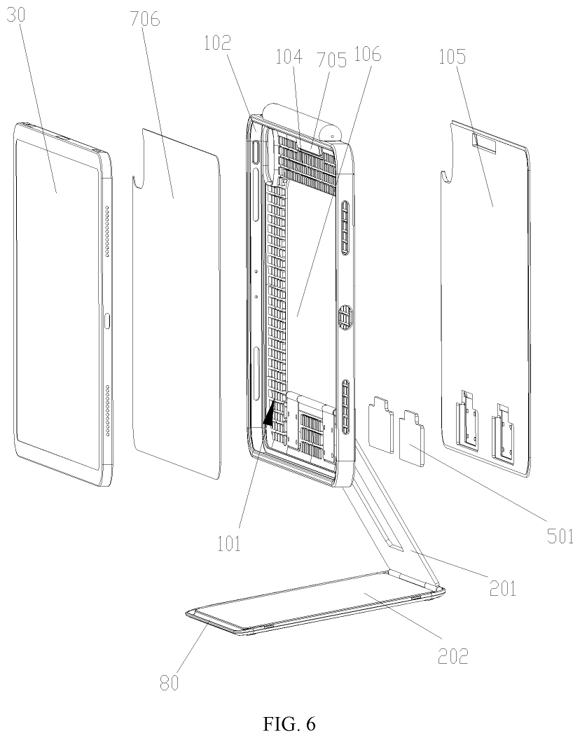

FIG. 6 is a schematic view illustrating the exploded structure of the electronic equipment support frame shown in FIG. 1. The electronic equipment support frame of this embodiment comprises a protective cover 10 and a supporting structure 20, and the electronic equipment comprises, but is not limited to, a tablet personal computer, a mobile phone, a display device and the like.

The protective cover 10 comprises a main plate 101 and a side plate 102 bent along the edge of the main plate 101, an accommodating space is enclosed by the main plate 101 and the side plate 102 for accommodating an electronic equipment 30, and a groove 103 is formed on the side of the main plate 101 facing away from the accommodating space. The shape of the protective cover 10 may be set according to different models of electronic equipments; preferably, in order to facilitate the processing and molding of the protective cover 10, the main plate 101 comprises a main plate body 104 and a mounting plate 105, wherein the main plate body 104 is integrally formed with the side plate 102, the main plate body 104 has a through groove 106, the mounting plate 105 is arranged on the inner side of the main plate body 104, covers the through groove 106 to form a groove 103 for arranging the supporting structure 20.

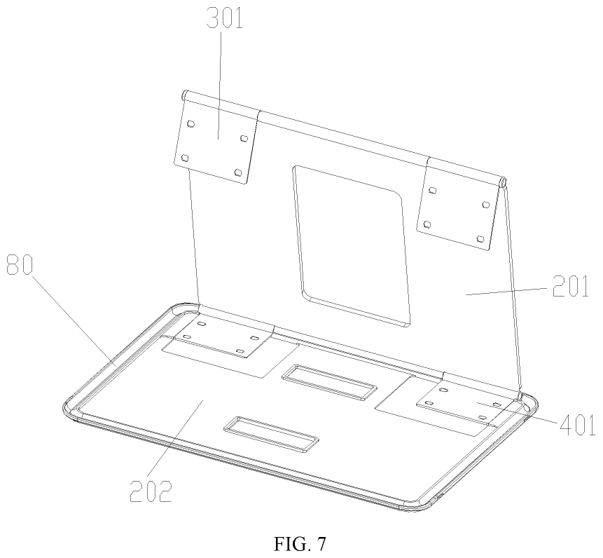

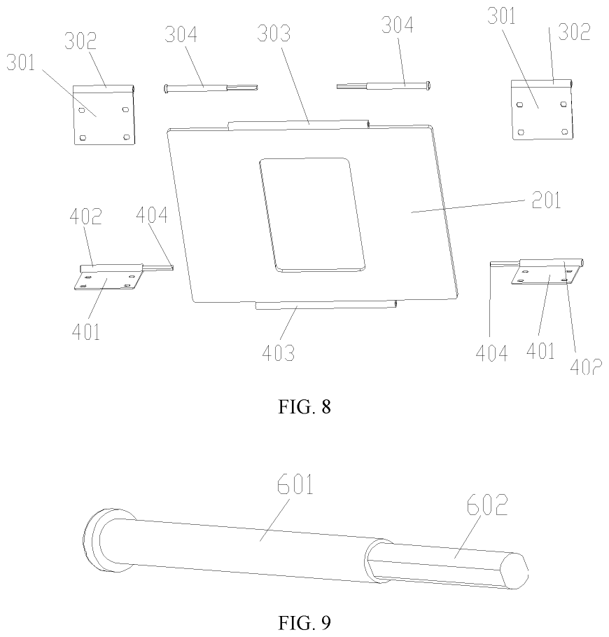

Please refer to FIG. 7 to FIG. 9, wherein FIG. 7 is a schematic structural diagram of the supporting structure of the electronic equipment support frame shown in FIG. 1; FIG. 8 is a schematic view illustrating the exploded structure of the supporting structure shown in FIG. 7; FIG. 9 is a schematic structural diagram of a first special-shaped section for a first rotating shaft of the supporting structure shown in FIG. 7. The supporting structure 20 is arranged in the groove 103 and comprises a first plate 201 and a second plate 202, wherein one end of the first plate 201 is pivotally connected with the main plate 101, and the other end thereof is pivotally connected with the second plate 202. When the supporting structure 20 is in a closed state, the supporting structure 20 is folded and received in the groove 103 to form an integrally-formed structure with the protective cover 10; and when the supporting structure 20 is in a supporting state, the first plate 201 can rotate around the main plate 101 and the second plate 202 respectively to form multi-angle support. As compared to the electronic equipment support frame currently available, this supporting structure 20 can provide multi-angle support and has a higher adjustable range of supporting height, and the supporting height can be adjusted according to the actual use situation of consumers. Furthermore, the supporting structure 20 can also be received, and the electronic equipment support frame only presents the appearance of a protective cover 10 after being received, so that the area occupied is small.

Pivotal connection can be achieved in many ways, such as through various hinge forms or through shafts in cooperation with shaft sleeves, all of which usually involve the use of pivot shafts, and the pivot shafts will occupy a certain thickness space; the pivot shafts either cannot be accommodated in the groove 103, or cause a low strength of the supporting structure 20 when the size thereof is reduced. In this embodiment, both ends of the first plate 201 are provided with pivot shafts or pivot shaft sleeves for forming pivotal connection, and the inner wall of the second plate 202 is provided with an accommodating groove 80 for accommodating the pivot shafts or the pivot shaft sleeves, so as to reduce the thickness of the electronic equipment support frame in the closed state.

Specifically, the electronic equipment support frame comprises two first mounting plates 301105 arranged on the main plate 101 at intervals, one end of each of the two first mounting plates 301105 is provided with a first mounting shaft sleeve 302, one end of the first plate 201 is provided with a first pivot shaft sleeve 303; the electronic equipment support frame further comprises two first rotating shafts 304 corresponding to the first mounting shaft sleeves 302, the first rotating shafts 304 pass through the first mounting shaft sleeve 302 and the first pivot shaft sleeve 303, the first plate body 201 is pivotally connected by the cooperation of the first pivot shaft sleeve 303 and the first rotating shaft 304. Preferably, the two first mounting plates 301105 are mounted on the mounting plate 105. For convenience of installation, this embodiment adopts two first rotating shafts 304, but in other embodiments, only one first rotating shaft 304 may be provided.

The electronic equipment support frame comprises two second mounting plates 401 arranged on the second plate 202 at intervals, one end of each of the two second mounting plates 401 is provided with a second mounting shaft sleeve 402, the other end of the first plate 201 is provided with a second pivot shaft sleeve 403; the electronic equipment support frame further comprises two second rotating shafts 404 corresponding to the second mounting shaft sleeves 402, and the second rotating shafts 404 pass through the second mounting shaft sleeve 402 and the second pivot shaft sleeve 403, and the first plate body 201 is pivotally connected by the cooperation of the second pivot shaft sleeve 403 and the second rotating shaft 404.

In this embodiment, both the first pivot shaft sleeve 303 and the second pivot shaft sleeve 403 are disposed in the receiving groove 80 of the second plate 202.

Preferably, for convenience of molding and reliability of connection, the pivotal structure of the first plate 201 and the main plate 101 is configured to be the same as the pivotal structure of the first plate 201 and the second plate 202, but in other embodiments, different pivotal structures can be adopted as long as the supporting height is increased by two times of pivotal rotation, all of which belong to the scope claimed in the present application.

Preferably, the mounting plate 105 is further provided thereon with two first reinforcing plates 501 for strengthening the strength of pivotal connection, and the two first reinforcing plates 501 correspond to the two first mounting plates 301; the second plate 202 is further provided thereon with two second reinforcing plates (not labeled) for strengthening the strength of pivotal connection, and the two second reinforcing plates correspond to the two second mounting plates 401.

Preferably, the first rotating shaft 304 comprises a first circular section 601 and a first special-shaped section 602, the first circular section 601 is matched and connected with the first mounting shaft sleeve 302, the first special-shaped section 602 is connected with the first pivot shaft sleeve 303; the second rotating shaft 404 comprises a second circular section and a second special-shaped section (not labeled, consistent with the structure of the first rotating shaft 304), wherein the second circular section is matched and connected with the second mounting shaft sleeve 402, and the second special-shaped section is connected with the second pivot shaft sleeve 403. By configuring parts of the first rotating shaft 304 and the second rotating shaft 404 in special shapes, the first plate 201 and the second plate 202 can generate damping with the first pivot shaft sleeve 303 and the second pivot shaft sleeve 403 when they are rotated, so as to maintain the supporting angle. More preferably, the cross sections of the first special-shaped section 602 and the second special-shaped section are runway-shaped.

Preferably, when the supporting structure 20 is in the closed state, the second plate 202 is in snap fit with the main plate 101. Specifically, a recess 701 is provided on the side of the second plate 202, and a protrusion 702 is provided on the mounting plate 105 at the joint with the through groove 106, the protrusion 702 is located in the groove 103, and the snap connection is realized by the cooperation of the protrusion 702 and the recess 701.

Preferably, in order to prevent the electronic equipment support frame from sliding when it is placed on the desktop, a plurality of silicone bumps 703 are provided on the outer wall of the second plate 202.

Preferably, the side plate 102 is further provided with a pen cover groove 704 for accommodating a pen cover, and the pen cover is used for accommodating a control pen used in cooperation with the electronic equipment. The pen cover is preferably magnetically attracted to the electronic equipment support frame, and a magnet 705 for attraction is provided on the inner wall of the main plate 101.

Preferably, in order to prevent the supporting structure 20 from being exposed, a decorative plate 706 is further provided on the mounting plate 105.

Preferably, in order to prevent the whole electronic equipment support frame from looking thick, the main plate 101 is arranged to be thick in the middle and low in the periphery, and the thick middle part corresponds to the supporting structure 20.

According to the present application, the main plate of the electronic equipment support frame is provided with a groove, a supporting structure is arranged in the groove, and the supporting structure can be pivotally rotated twice; as compared to the electronic equipment support frame currently available, the electronic equipment support frame of the present application can provide multi-angle support and has a higher adjustable range of supporting height, so that the supporting height can be adjusted according to the actual use situation of consumers. Furthermore, the supporting structure can also be received, and the electronic equipment support frame only presents the appearance of a protective cover after being received, so that the area occupied is small.

What described above are only embodiments of the present application, and thus are not intended to limit the patent scope of the present application; any equivalent structural or equivalent process changes made by using the contents of the specification and the attached drawings of the present application, or direct or indirect application in other related technical fields, are all included in the scope claimed in the present application.

What is claimed is:

1. An electronic equipment support frame, being characterized in that, comprising:
a protective cover, comprising a main plate and a side plate bent along the edge of the main plate, wherein an accommodating space is enclosed by the main plate and the side plate for accommodating the electronic equipment, and a groove is formed on the side of the main plate facing away from the accommodating space;
a supporting structure, being disposed in the groove and comprising a first plate and a second plate, wherein one end of the first plate is pivotally connected with the main plate, and the other end thereof is pivotally connected with the second plate;
wherein when the supporting structure is in a closed state, the supporting structure is folded and received in the groove to form an integrally-formed structure with the protective cover; when the supporting structure is in a supporting state, the first plate can rotate around the main plate and the second plate respectively to form multi-angle support.

2. The electronic equipment support frame according to claim 1, being characterized in that, both ends of the first plate are provided with pivot shafts or pivot shaft sleeves for forming pivotal connection, and the inner wall of the second plate is provided with an accommodating groove for accommodating the pivot shafts or the pivot shaft sleeves, so as to reduce the thickness of the electronic equipment support frame in the closed state.

3. The electronic equipment support frame according to claim 2, being characterized in that, the electronic equipment support frame comprises two first mounting plates arranged on the main plate at intervals, one end of each of the two first mounting plates is provided with a first mounting shaft sleeve, one end of the first plate is provided with a first pivot shaft sleeve; the electronic equipment support frame further comprises two first rotating shafts corresponding to the first mounting shaft sleeves, the first rotating shafts pass through the first mounting shaft sleeve and the first pivot shaft sleeve, and the first plate body is pivotally connected by the cooperation of the first pivot shaft sleeve and the first rotating shaft.

4. The electronic equipment support frame according to claim 3, being characterized in that, the electronic equipment support frame comprises two second mounting plates arranged on the second plate at intervals, one end of each of the two second mounting plates is provided with a second mounting shaft sleeve, the other end of the first plate is provided with a second pivot shaft sleeve; the electronic equipment support frame further comprises two second rotating shafts corresponding to the second mounting shaft sleeves, the second rotating shafts pass through the second mounting shaft sleeve and the second pivot shaft sleeve, and the first plate body is pivotally connected by the cooperation of the second pivot shaft sleeve and the second rotating shaft.

5. The electronic equipment support frame according to claim 4, being characterized in that, the main plate comprises a main plate body and a mounting plate, wherein the main plate body is integrally formed with the side plates, the main plate body has a through groove, the mounting plate is arranged at the inner side of the main plate body, and the two first mounting plates are mounted on the mounting plate.

6. The electronic equipment support frame according to claim 4, being characterized in that, the mounting plate is further provided thereon with two first reinforcing plates for strengthening the strength of pivotal connection, and the two first reinforcing plates correspond to the two first mounting plates; the second plate is further provided thereon with two second reinforcing plates for strengthening the strength of pivotal connection, and the two second reinforcing plates correspond to the two second mounting plates.

7. The electronic equipment support frame according to claim 4, being characterized in that, the first rotating shaft comprises a first circular section and a first special-shaped section, the first circular section is matched and connected with the first mounting shaft sleeve, the first special-shaped section is connected with the first pivot shaft sleeve; the second rotating shaft comprises a second circular section and a second special-shaped section, wherein the second circular section is matched and connected with the second mounting shaft sleeve, and the second special-shaped section is connected with the second pivot shaft sleeve.

8. The electronic equipment support frame according to claim 7, being characterized in that, the cross sections of the first special-shaped section and the second special-shaped section are runway-shaped.

9. The electronic equipment support frame according to claim 1, being characterized in that, when the supporting structure is in a closed state, the second plate is in snap fit with the main plate.

10. The electronic equipment support frame according to claim 1, being characterized in that, the side plate is further provided with a pen cover groove for accommodating a pen cover, and the pen cover is used for accommodating a control pen used in cooperation with the electronic equipment.
